(19) United States
(12) Patent Application Publication
(10) Pub. No.: US 2004/0099710 A1
(43) Pub. Date: May 27, 2004

(54) Optical ball height measurement of ball grid arrays

(76) Inventor: Bernd Sommer, Colombier (CH)

Correspondence Address: PEARNE & GORDON LLP, 1801 EAST 9TH STREET, SUITE 1200, CLEVELAND, OH, 44114-3108, US

(21) Appl. No.: 10/402,460

(22) Filed: Mar. 28, 2003

Related U.S. Application Data
(63) Continuation of application No. PCT/CH00/00533, filed on Sep. 29, 2000.

(51) Int. Cl. B23K 31/12

(52) U.S. Cl. 228/103

(57) ABSTRACT

The ball attach step of grid array (BGA) devices requires precise control of the ball shape and height. All balls must have identical height within tight tolerances, to assure proper soldering to the PC board.

Solution: A mechanism is proposed, involving a CCD camera, image processing system, and a specific optical setup to inspect the balls in a complete three-dimensional view to the camera. This-involves a dedicated micro-mirror module and an illumination arrangement. The ball XY position is measured in direct view, and the ball height is measured in the image from the micro mirrors. The camera can be either a standard video device, a very high resolution array camera, or even a line scan camera.

### REFERENCE DATA

This patent application is the continuation of the international patent application PCT/CH00/00533, published as WO0227267 and filed on Sep. 29, 2000.

### FIELD OF THE INVENTION

One driving force for semiconductor industry is the miniaturization of components. The recent trend is to package the chip into Chip Scale Package (CSP), a package which is almost the size of the silicon chip itself. Other packaging forms such as Ball Grid Arrays (BGA), Micro-BGA, or fine pitch BGA (FPBGA) are representations of the same trend.

These packages use an epoxy substrate (either flexible or rigid, similar to a, printed circuit board) to mount the silicon chip, make the electrical contacts from the chip to the substrate via wire bonds or direct bump bonding, and use the solder balls in linear or array form as electrical contacts.

These devices are typically molded on the top side, whereas the bottom surface is an array of solder balls. Various standards between 0.4 and 2.5 mm pitch between the balls have been defined. The matrix form of solder balls allow a very high number of electrical contacts per device. Up to 1000 electrical contacts on a small package are obtained.

However, there are always multiple complications on new technologies to overcome: These packages are mounted to the computer boards using reflow technology (infrared radiation), to heat the solder, and then to solder them as a surface mount to the pad contact points of the PCB. After soldering, the contacts are not visible for inspection. Repair of defect solder points is practically impossible. Every bad solder point on any of the 1000 balls will inevitably require to discard the full device, or even the whole computer board.

Consequently, the quality, volume, XY location and height of all solder balls must follow a very strict tolerance guideline. The production output must be 100% inspected for any little defect. Specifically the coplanarity and height of every solder ball is the most critical parameter.

### DESCRIPTION OF THE RELATED ART

There is no easy way to measure the height of solder balls on an opaque epoxy board. The surface of solder is highly random colored, dull or shiny, and residues from flux material may further complicate things. Height measurement requires a camera view from horizontal direction, which is feasable for the outside row of balls only.

So far, the industry has produced a number of substitute solutions, such as diagonal light or pattern projection onto the ball, or to the epoxy background between the balls. Those methods all have shortcomings, because they never catch the height of the very surface point, but from a diagonal shoulder point of the ball. Also, projection to the epoxy suffers from uneven solder mask thickness, and other epoxy surface effects. In addition, diagonal camera views suffer from focusing problems and image non-linear scaling problems since different rows of balls have different distance to the camera, and consequently different scaling effects.

### BRIEF SUMMARY OF THE INVENTION

In the present patent, I describe a method which is not limited by any of these difficulties. It allows to measure the ball height of all balls simultaneously in only one or two camera images. The method measures the true height of the ball at ist highest point, and it uses a prefectly flat reference plate as height reference for every ball. This allows to execute a “Seating plane” calculation, to extract the three lowest balls which define the triangle on which the device will sit if you place it on the PCB board, and extract the worst gap between any other ball and this plane.

Another object of the invention is to test the epoxy plate of the BGA for flatness. Non-flat epoxy plates can arise from the molding process, from multi-layer lamination, or other manufacturing steps. Naturally, non-flat epoxy boards automatically cause coplanarity errors across the deivce. Measurement of this effect requires that a perfectly flat reference plane is used, which is independent of the epoxy plane.

Another object of the invention is to assure that there is no material between the balls, possibly solder material, which may cause shortcuts later. It must be assured that the epoxy material between the solder balls is completely free and even.

Finally, the object is to measure the XY ball location of every ball, and to measure the XY centering of the highest point of the solder ball with respect to ist contour (symmetry of the ball).

This invention provides a method and means of accurately and repeatably measuring the XY position and height of every ball on BGA's, as well as the ball centering and spherical symmetry. The invention involves an array camera, a beam splitter mirror, a specific illumination, a micro-prism a mounting plate with special arrangement of the mirrors and holes, on which the BGA device is placed, a 3D image processing system, and software and algorithms for evaluation of the evaluation of the imaging signals. The ball XY position and centering is measured by evaluation of the reflective spot on the ball flat top surface, and the complete ball contour. The ball height is measured by evaluation of the shadows generated by the balls on the side micro mirrors.

### BRIEF DESCRIPTION OF THE DRAWINGS

FIG. 1 describes the principal arragnement of all components of the invention. The vacuum pickup of the external handling system (1) holds the BGA test device (2) into test position. The bails (3) are oriented downward. The micro-prima mirror-plate (4) is mounted on top of the inspection module (11) in a way that all balls (3) of the BGA are inserted into the appropriate holes (5) of the plate. A beam splitter (semi-transparent mirror) (6) allows the illumination (7) to pass and illuminate the BGA device (2) including all balls (3) simultaneously. The vertical portion of reflective light (9) from the balls is reflected by the beam splitter (6) to right direction, and enters the camera CCD sensor (8). Additional illumination components (12) for darkfield illumination are helpful for a second shadow projection image.

FIG. 2 describes an alternate system setup. The CCD camera device (8) is mounted vertically behind the beam splitter (6), and the illumination (7) is mounted in horizontal direction. The light travels from light source (7) to the beam splitter (6), is reflected to (9), and illuminates the balls (3) in the same way as in FIG. 1. The vertical portion of the reflected light (11) passes the beam splitter (6) and enters the CCD camera sensor (8). Both arrangements (FIG. 1 and FIG. 2) are functionally equivalent.

FIG. 3 describes the principal optical reflection law of light on metal surfaces. This is used to extract the highest point XY position of the ball.

FIG. 4 shows the principal image signal for the highest XY position of the ball.

FIG. 5 is a bottom view up to the micro mirror plate, where four linear side mirrors per ball are mounted to left, right, top and bottom side.

FIG. 6 is a variation of FIG. 5 where four mirrors per ball are mounted in the four 45 degree corner locations. This allows slightly larger mirrors.

FIG. 7 is another variation of FIG. 5, where the side mirrors are manufactured as a ring conus around the central drill hole.

FIG. 8 shows the side view cross section through the mirror plate, the BGA device and one ball.

FIG. 9 shows a detailed mathematics of the ball height measurement.

FIG. 10 demonstrates the principal camera view on the plate and micro mirrors, including the ball and shadow cast from the ball tip to the side mirrors.

FIG. 11 demonstrates the shadow cast from the alternate illumination from very low angles. The side illumination casts a shadow on the opposite mirror. Since the light sources are fixed points in space, the shadow location is exclusively dependent on the height of the ball.

### DETAILED DESCRIPTION OF THE INVENTION

The proposed method is applicable to any family of BGA devices. It is not limited to a certain class of BGA's, or number of balls. In the further discussion, however, I will take a 5×5 ball micro-BGA device as an example.

The principle of measurement is based on a CCD array camera, which is mounted vertically below the device. All balls are within the same camera image, and also within the focus of the camera optics. With proper illumination from top side, this image is used to measure each ball precisely in XY dimension and position. The solder balls appear dark, and the epoxy substrate around the balls appear bright. This allows to measure the contour of the ball precisely.

From the vertical illumination, the flat center portion of the solder ball creates a direct light reflection into the camera. This reflective spot is measured as the XY location of the flat surface area of the ball. It must be in the exact center of the solder ball. Any deviation from the center can be interpreted as a shape deformation of the ball.

To measure the height of the solder ball, a side mirror technique is used. Although this technique is fairly standard in other applications, ist utilization for BGA inspection is not evident. This is because the spaces between balls is very small. I therefore suggest a massive plate, made of steel, glass, or other rigid material, which is manufactured in a fashion to include a grid of drill holes for the balls itself, plus micro prisma side mirrors around each ball, oriented in ca. 45 degree slant. The camera utilizes these mirrors to have a side view to the ball, and to execute a true height measurement of the ball.

The illumination for the side view must be specifically configured. A vertical coplanar toplight can be used to illuminate each side mirror. The light will be reflected into horizontal direction (because the mirror is oriented 45 degrees), and it will pass across the ball opposite side. Here it will hit the other side mirror, and being reflected back into the carnera.

Light at the outside edge of the mirrors will be reflected at a higher level across the ball, and light at the inner edge of the mirrors will be reflected at low level. If the BGA device is adjusted correctly, the low level light will hit the ball, and not cross to the other side mirror. Therefore, that mirror will appear black at ist inner portion. The outside portion will appear bright, because the light is higher than the ball top height, and will not be stopped.

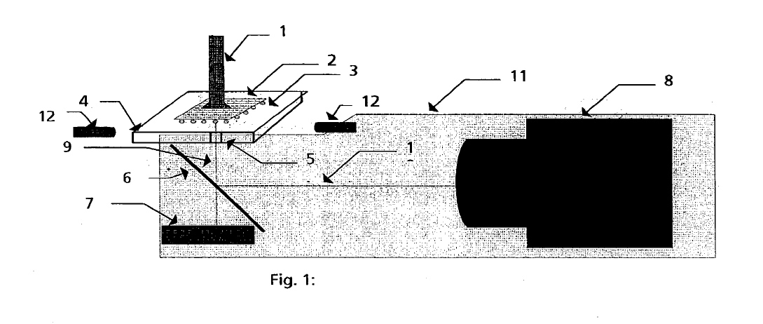

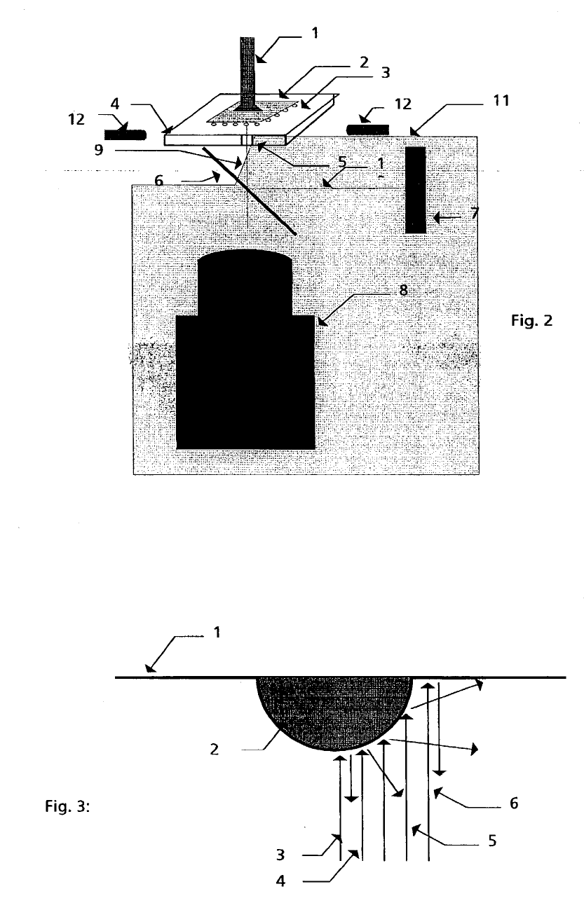

This basic measurement principle is realized in the setup as described in FIG. 1 and 2. The system setup assumes that an external handling system transports the microBGA device with balls DOWN. A camera, beam splitter and illumination unit is arranged as shown in FIG. 1. It describes the principal arragnement of all components of the invention. The vacuum pickup of the external handling system (1) holds the BGA test device (2) into test position. The balls (3) are oriented downward. The micro-prima mirror plate (4) is mounted on top of the inspection module (11) in a way that all balls (3) of the BGA are inserted into the appropriate holes (5) of the plate. A beam splitter (semi-transparent mirror) (6) allows the illumination (7) to pass and illuminate the BGA device (2) including all balls (3) simultaneously. The vertical portion of reflective light (9) from the balls is reflected by the beam splitter (6) to right direction, and enters the camera CCD sensor (8). Additional illumination components (12) for darkfield illumination are helpful for a second shadow projection image.

FIG. 2 describes an alternate system setup. The main difference from FIG. 1 is the arrangement of the illumination and camera. In some systems, the vertical arrangement of the camera may have advantages. Functionally, both FIG. 1 and FIG. 2 are equivalent. The CCD camera device (8) is mounted vertically behind the beam splitter (6), and the illumination (7) is mounted in horizontal direction. The light travels from light source (7) to the beam splitter (6), is reflected to (9), and illuminates the balls (3) in the same way as in FIG. 1. The vertical portion of the reflected light (11) passes the beam splitter (6) and enters the CCD camera sensor (8). Both arrangements (FIG. 1 and FIG. 2) are functionally equivalent.

The camera, optics, beam splitter, and illumination are mounted in a “Camera Module”, which is easily assembled to any handling system. The horizontal arrangement of the camera reduces the size of the module, and allows easy access to all components in the handling system.

The view of the camera is vertically to the bottom side of the BGA device. From the coplanar illumination (vertically from bottom up, through the beam splitter), each ball is illuminated flat from the top. Because of the roundness of the balls, the flat surface side is illuminated most, while the ball shoulders reflect less light back into the camera (FIG. 3). The BGA epoxy substrate (1) holds the ball (2). The illumination from bottom side is made of parallel vertical light (3)-(6). The solder surface reflects the light in a specific way: (3) hits the center of the ball. The surface is horizontal, so the optical law of reflection predicts that the light is reflected back vertically down. Because the camera is mounted on bottom side, this spot will therefore appear bright in the camera image. Light (4) and (5) are both off-center, they see a slanted portion of the ball surface, and the reflected light will have various orientations, none of them being reflected back down into the camera, so this portion of the ball appears black. Only light (6) to the substrate surface will be reflected back into the camera, so the substrate itself appears bright.

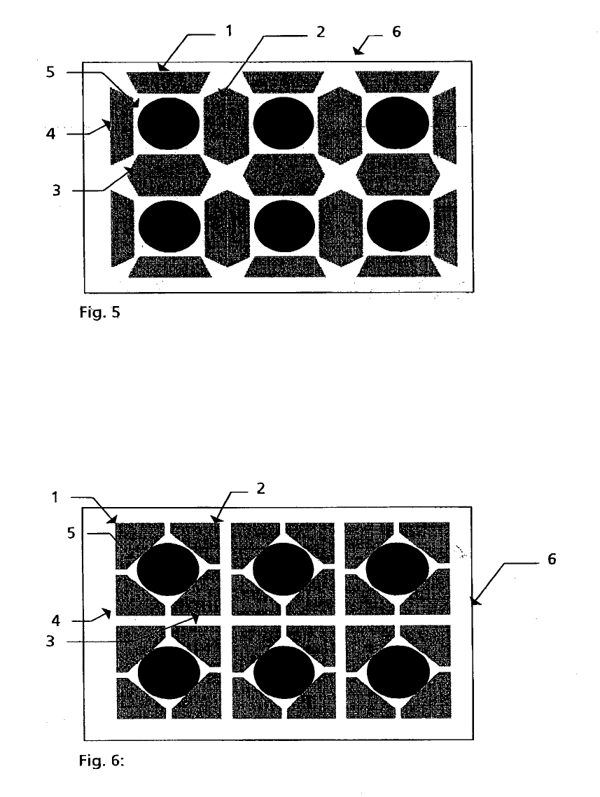

Consequently, the camera image of the ball is shown in FIG. 4. The epoxy substrate (1) appears bright, the soldeer ball itself (2) is dark, and the center flat spot of the solder ball (3) appears bright.

The position and centering of the ball is measured in the attached Image Processing System. The procedure must be set as follows:

The camera pixel data are digitized into a frame grabber,

The IPU (Image Processing Unit) scans the image area for all pixel darker than a threshold TH,

These pixel belong to the dark ball, but not to the inside ball center area.

The area center of mass (in X,Y) of the black ball area is calculated:

B_AREA =˜dm B_CM(x) =˜x *dm B_CM(y) =˜y* dm

(all black pixel in image)

The white spot inside the dark ball is calculated for area and center of mass

S_AREA =˜dm S_{˜}CM(x)=Ix * dm S_CM(y)=˜y * dm

(all white pixel inside ball)

From these primary parameters, the followign physical measurement results are extracted:

The ball size is Size=B₁₃AREA+S_AREA

The ball flatness Flatness=S_AREA

The ball excentricity EXX=S_CM(x)−B_CM(x), EYY=S_CM(x)−B_CM(y)

These are all 2D ball measurement parameters. Due to the manufacturing process, the ball size and height are normally correlated. However, a true ball height measurement may be important to exclude irregularities in the production.

In the following a measurement of the True 3D Ball Height according to the metod and using the device of the invention is described.

To accomplish the true 3D ball height measurement, the same vertical camera setup is utilized. Because of the vertical arrangement of the camera, all balls are at the same distance to the camera, so they all are within the depth of focus. We propose a “Micro Mirror Array” (MMA) for height measurement. This array is a plate with integrated mirror modules. A first possible arrangement is shown in FIG. 5. The plate (6) contains a grid of drill holes (5) for the balls. The BGA device is placed on the top side of the plate, and the balls appear through the holes to the bottom side (view). Each hole has a set of four prisma side mirrors (1),(2),(3),(4) arranged in four sides. Each mirror has a 45 degree orientation towards the ball.

A second possible arrangement of the side mirrors is shown in FIG. 6. Each ball has four side mirrors. However, the arrangement is in the upper left (1), upper right (2), lower left (4), and lower right (3) corners. This arrangement has the advantage of more space of the mirrors, but the shape itself is more complex.

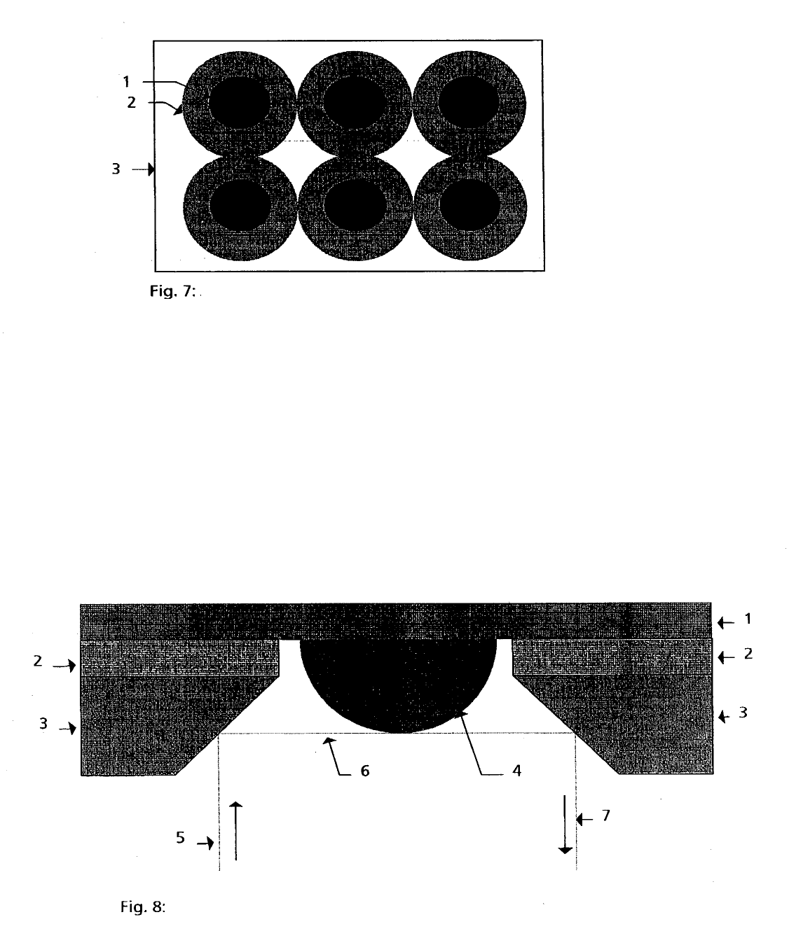

A third possible arrangement of the side mirrors is demonstrated in FIG. 7. Each hole has a drill conus of 45 degree slope, round, and symmnetric around the hole. The conus itself is made made as a mirror, so the light reflects exactly the same way as in the other two examples.

FIG. 8 shows a side view cross section through the mirror setup. (1) is the BGA epoxy substrate, placed on top of the mirror plate (2). This plate has the drill hole and the ball (4) is placed inside the hole. The side mirrors (3) are arranged on either side, and a ray of light, as demonstrated in (5) from vertical bottom side is reflected on the left side mirror, passes the ball horizontally (6), being reflected again on the right side mirror, and return (7) into the camera. You see that other rays parallel to (5) will either hit the ball, or pass horizontally at a greater distance.

FIG. 9 is a more detailed mathematical explanation of what happens. The light travel path is:

From the illumination behind the beam splitter (FIG. 1), the light passes the beam splitter, and hits the MMA as “confocal toplight” (almost parallel vertical illumination);

The light hits the side mirrors, and is deflected into horizontal direction;

The light passes the ball, and casts a shadow profile of the ball into the opposite side mirror;

From here, the light is deflected to vertical direction again, hits the beam splitter, and is deflected into the camera optics.

This method allows a very precise measurement of the ball height. Any variation in height will immediately change the width of the visible black ball portion inside the side mirror view. Due to the exact 45 degree orientation of the mirrors, the change in ball width is exactly double of the height change.

The measured value M is the primary parameter, which is measured in the camera image, by means of the 3D image processing system. It is

M=a+b+c

From this, the height (H) of the ball from the epoxy base is calculated as:

H=d+e

and (due to the 45 degree mirror orientation)

a=c=d

From this, we get

H=(M−b)/2+e

This is the true measurement result of the single ball height from the epoxy basis.

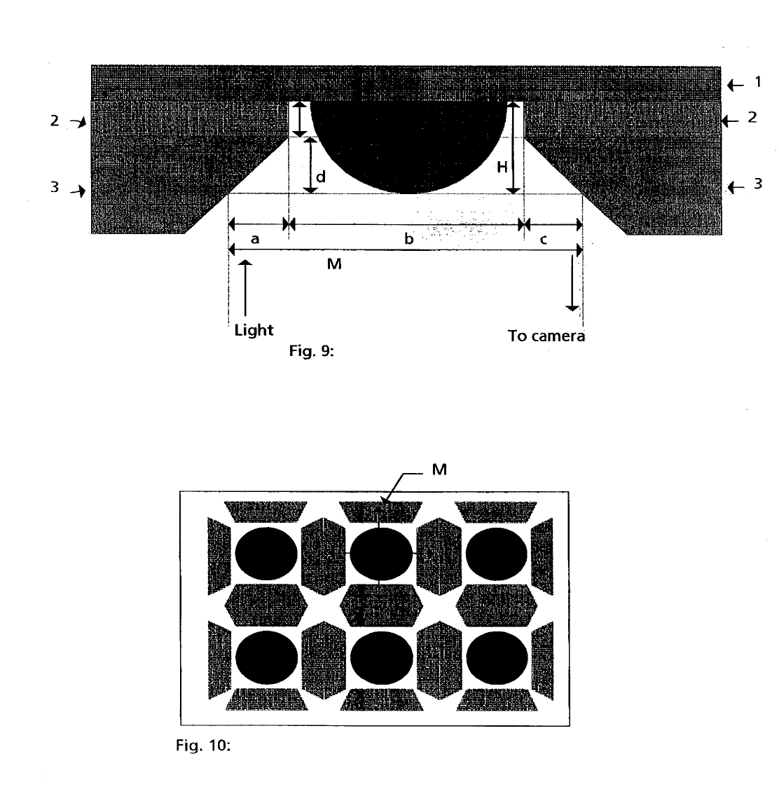

The measurement of M is executed in the camera image. This is done using edge detection algorithms and subpixel operation of the dark ball portion in the side mirror image (FIG. 10). The measurement value M is the position of the dark shadow edge in all four side mirrors.

In the following a measurement according to the shadow projection method of the invention is described.

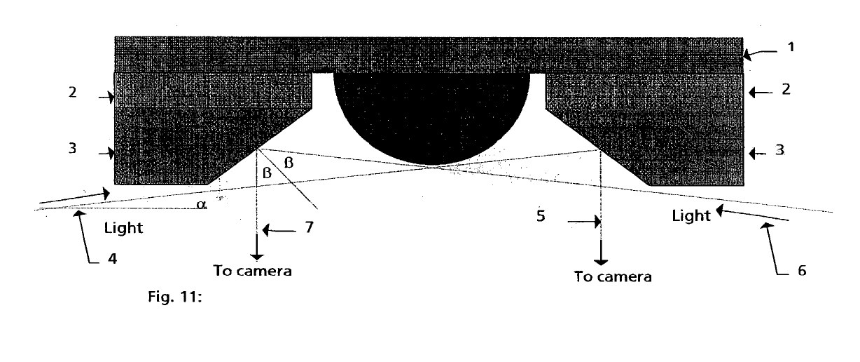

Another method of illumination is the “Dark Field” illumination (FIG. 11). The BGA substrate (1) on the steel plate (2)and the micro mirrors (3) are the same as FIG. 8. However, the light (4) is now from horizontal angles, passes the ball, and cast a shadow on the opposite side mirror (3), and reflected into the camera (5). Vice versa, a second side illumination (6) passes from right to left, and generates a signal (7) in the camera. The position of the shadow is a direct measure for the ball height. It is possible to arrange a ring of light sources around the device, directly below the plate. It is also possible to use single point light sources. The angle of incident light is α. In one example, the value must be 10 degrees. The orientation of the mirrors (normal vector) is exactly 50 degrees. The reflected beam has exactly 90 degrees orientation and is directly detected by the camera. Other angles are possible.

In the following a measurement of seating plane according to the metod and using the device of the invention is described.

The measurement procedure yields a ball height result for every ball in the device: H(i,j) for all rows (i) and columns (j) of the BGA array. These data are the primary measurement data.

However, the height of individual balls is only the first step in the full BGA analysis. The epoxy package may not sit properly on the measurement plate. Dust or other reasons may cause a gap between the measurmeent plate and the BGA. Consequently, the height of every ball is affected. It is therefore important to execute a correlation analysis among all balls of the BGA array.

Clearly, every ball height must sit on a plane (in XYZ space). When the BGA device is placed on the PCB, this ball height plane will sit directly, on the PCB surface. Every variation of any ball height will cause some balls to produce a space between the ball and the PCB.

A “Best Fit Plane” algorithm calculates the maximum ball height difference between the highest and the lowest ball in the BGA. The lowest balls will touch the PCB surface, so the device will generally sit on three or more of the lowest balls. The other will not touch the ground, but produce some space. The maximum of all spaces is the required result. If the maximum does not exceed a given tolerance, the device can be classified as OK. Otherwise, it will be classified as REJECT.

1. A method for determining the XY position of BGA ball grid arrays, column grid arrays, and similar surface mount integrated circuit chips, using an optical sensor, said method comprising the steps of:
providing a micro mirror plate with a matrix of holes for the balls and flat or round micro-mirrors arranged around each hole, said micro-mirrors, having a, diagonal orientation,
illuminating said micro-mirrors with a set of illumination components,
providing a CCD array camera arranged so that the reflected light enters said camera,
combining camera and illumination in one setup,
evaluating the imaging signals from the camera with a 3-D image processing system and algorithms.

2. The method of claim 1, further comprising a step of providing a beam splitter unit (6) to combine camera and illumination in one setup.

3. The method of claim 1, further comprising a step of determining the coplanrity of said BGA ball grid arrays, column grid arrays, and similar surface mount integrated circuit chips.

4. The method of claim 1, using a 3-dimensional optical sensor technique.

5. The method of claim 1, wherein said micro-mirrors are arranged at the bottom side of said holes.

6. The method of claim 1, in which the micro mirror plate contains a grid of round drilled rings around each ball drill hole, which are oriented at an angle of approximately 45 degree to the ball.

7. The method of claim 1, in which the micro mirror plate has four micro mirrors per ball, which are arranged at the left, right, top and bottom side of each ball, and oriented in an angle of approximately 45 degrees.

8. The method of claim 1, in which the micro mirror plate has four micro mirrors per ball, which are arranged in the 45 degree corners at the upper left and right, and the lower left and right side of each ball, and oriented in an angle of approximately 45 degrees.

9. The method of claim 2, in which said CCD camera is mounted horizontal on the side of the device, and said beam-splitter unit is a 45 degree beam splitter mounted before said camera in a fashion, that the camera views the device from the vertical bottom side.

10. The method of claim 9, in which the illumination component is mounted vertically below the beam splitter, and illuminates the balls vertically. .

11. The method of claim 2, in which said CCD camera is mounted vertically below the device, and said beam splitter unit is a 45 degree beam splitter mounted before the camera.

12. The method of claim 11, in which the illumination component is mounted at the side of the beam splitter, and illuminates the balls through the beam splitter vertically.

13. The method of claim 10, in which said 3-D image processing system evaluates the camera image data, measures the central bright spot XY position on every BGA ball, and the dark ball size and position, and calculates the ball size and symmetry of the ball shape.

14. The method of claim 13, in which said 3-D image processing system evaluates the camera image data of the micro side mirror shadows generated by the ball height, extracts the position of every shadow, and calculates the height of the balls.

15. The method of claim 14, in which said image processing system uses the ball XY position from (9) and the Z height position from (10), and calculates the seating plane of all balls, and extracts the ball with the worst distance from the seating plane.

16. The method of claim 1, in which the micro mirror plate contains a grid of round drilled rings around each ball drill hole, which are oriented at angles between 30 to 45 degrees to the ball.

17. The method of claim 1, in which the micro mirror plate has four micro mirrors per ball, which are arranged at the left, right, top and bottom side of each ball, and oriented at angles between 30 and 45 degrees.

18. The method of claim 1, in which the micro mirror plate has four micro mirrors per ball, which are arranged in the 45 degree corners at the upper left and right, and the lower left and right side of each ball, and oriented at angles between 30 and 45 degrees.

19. The method of claim 16, in which the illumination component is mounted at flat angles between 0 and 45 degrees at the side of the BGA device.

20. The method of claim 19, in which said CCD camera is mounted vertically below the device, and said beam-splitter unit is a 45 degree beam splitter mounted before the camera.

21. The method of claim 19, in which said CCD camera is mounted horizontal on the side of the device, and said beam-splitter unit is a 45 degree beam splitter mounted before the camera in a fashion, that the camera views the device from the vertical bottom side.

22. The method of claim 19, in which said 3-D image processing system evaluates the camera image data, measures the central bright spot XY position on every BGA ball, and the dark ball size and position, and calculates the ball size and symmetry of the ball shape.

23. The method of claim 22, in which said 3-D image processing system evaluates the camera image data of the micro side mirror shadows generated by the ball height, extracts the position of every shadow, and calculates the height of the balls.

24. The method of claim 23, in which said image processing system uses the ball XY position from (18) and the Z height position from (19), and calculates the seating plane of all balls, and extracts the ball with the worst distance from the seating plane.

25. Optical test device for testing BGA ball grid arrays, column grid arrays, and similar surface mount integrated circuit chips, comprising
a plate (4) provided with a matrix of holes (5) arranged so that each ball (3) of said said integrated circuit (2) can be inserted into one hole of said plate, each hole being provided with at least one micro-mirror,
an illumination for illuminating said balls and said mirrors,
a camera (8) arranged so that the light reflected by said micro-mirror and/or by said balls enters said camera,
an image processing system for evaluating the imaging signals from said camera.

26. The device of claim 25, wherein said image processing system determines the XY position and the coplanarity of said balls.

27. The device of claim 26, wherein said micro-mirrors are provided at the bottom side of each said hole.

28. The device of claim 27, wherein said micro-mirrors are a set of flat or round mirrors arranged around each hole with diagonal orientation.

29. The device of claim 28, wherein said camera is a CCD array camera.

30. The device of claim 29, further comprising a beam splitter unit to combine the light from said illumination and the light reflected by said micro-mirrors in one setup.

31. The device of one of the claims 25 to 30, wherein said micro-mirrors are oriented at an angle of approximately 45 degree with respect to the surface of said plate.

32. The device of one of the claims 25 to 31 ,wherein said camera, said beam splitter and said illumination are mounted in a camera module.

33. Micro mirror massive plate for testing BGA ball grid arrays, column grid arrays, and similar surface mount integrated circuit chips, comprising:
a grid of drill holes arranged so that one ball can be inserted in each hole, micro-prisma side mirrors arranged around each ball and oriented in ca. 45 degree slant.

34. The method of claim 12, in which said 3-D image processing system evaluates the camera image data, measures the central bright spot XY position on every BGA ball, and the dark ball size and position, and calculates the ball size and symmetry of the ball shape.
